(19) United States
(12) Patent Application Publication
(10) Pub. No.: US 2026/0172370 A1
(43) Pub. Date: Jun. 18, 2026

(54) SWITCH CONTROL ARCHITECTURE AND DISTRIBUTED CONTROL FOR CROSSBAR SYSTEMS

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/418,798

(22) Filed: Dec. 12, 2025

Related U.S. Application Data
(60) Provisional application No. 63/734,022, filed on Dec. 13, 2024.

(51) Int. Cl. H04L 49/101; H04L 41/0663; H04L 41/0896

(52) U.S. Cl. CPC H04L 49/101; H04L 41/0663; H04L 41/0896

(57) ABSTRACT

A device includes a plurality of digital signal processors (DSPs) and analog crossbars operable to connect with the DSPs. A switch controller facilitates control signaling between the DSPs and the crossbars, enabling dynamic coordination of traffic flow, resource allocation, and crossbar configurations. The device supports integrated in-band (IB) and out-of-band (OOB) communication, proactive monitoring of signal metrics for failover prediction, and synchronization techniques to minimize latency and ensure system coherence. The architecture further incorporates load balancing, fault tolerance, and distributed control mechanisms to optimize performance in high-speed network environments.

### RELATED APPLICATION

This application claims the benefit of U.S. Provisional Application No. 63/734,022, filed Dec. 13, 2024, the disclosure of which is incorporated herein by reference in its entirety.

The examples discussed in the present disclosure are related to switch control architecture and distributed control for crossbar systems.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device may include digital signal processors (DSPs) and analog crossbars connected to DSPs. The device may include a switch controller which may facilitate control signaling between DSPs and analog crossbars. The switch controller functionality may be provided by a DSP or by a separate component. A method may include connecting DSPs to analog crossbars; and communicating control signaling between the DSPs and the analog crossbars using a switch controller.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including a switch controller.

FIG. 2 illustrates an example device including a switch controller.

FIG. 3 illustrates an example timing diagram used for a switch controller.

FIG. 4 illustrates an example process flow of a device for a switch controller.

FIG. 5 illustrates an example communication system operable for a switch controller.

FIG. 6 illustrates a diagrammatic representation of a machine in the example form of a computing device within which a set of instructions, for causing the machine to perform any one or more of the methods discussed herein, may be executed.

FIG. 7A illustrates an example block diagram of a data center.

FIG. 7B illustrates an example switch device.

FIG. 7C illustrates an example switch device.

FIG. 7D illustrates an example switch device.

### DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

Examples of the described herein will be explained with reference to the accompanying drawings.

A switch controller may provide various functions that may enhance bandwidth utilization and enhance latency. A switch controller may manage crossbar configurations and resource allocation. The architecture of the switch controller may provide for distribution of control signaling between different components. The architecture of the switch controller may also provide for failover.

A device may include digital signal processors (DSPs) and analog crossbars that may be connected to the DSPs. A switch controller may facilitate control signaling between the DSPs and analog crossbars. The architecture for the device may allow for distribution of control signaling between the switch controller and the DSPs—which may facilitate enhanced resource management and enhanced redundancy.

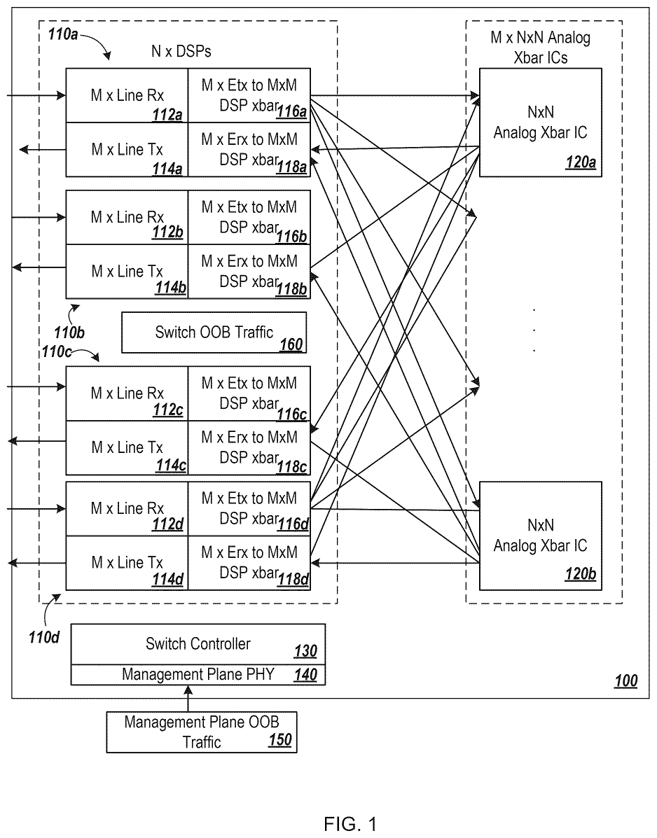

As illustrated in FIG. 1, an analog electrical circuit switch (AECS) may include one or more DSPs 110a, 110b, 110c, 110d. The AECS may include a switch controller 130, a management plane physical layer, and/or management plane out-of-band (OOB) traffic 150. The AECS may include one or more analog crossbar (“xbar”) integrated circuits (IC) (e.g., analog crossbars 120a, 120b). In this example, the switch controller may be a separate component from a DSP 110a, 110b, 110c, 110d. The switch controller 130 may interface with the management plane physical layer 140. The management plane physical layer may communicate with the management plane using management plane OOB traffic 150.

A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A PMD device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In some examples, the switch controller 130 may be a microcontroller unit (MCU). Alternatively or in addition, the switch controller 130 may be a DSP.

Switch out-of-band (OOB) traffic may be traffic among the SC 130, DSP 110a, 110b, 110c, 110d, analog crossbars 120a, 120b carried on a different network and physical layer than IB; may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS via management plane physical layer (PHY) to configure and manage the AECS.

When the switch controller 130 is separate from a DSP 110a, 110b, 110c, 110d, there may be a dedicated OOB connection between DSPs 110a, 110b, 110c, 110d, analog crossbars 120a, 120b, and/or the switch controller 130 (which may be a microcontroller unit). Alternatively or in addition, the connection between DSPs 110a, 110b, 110c, 110d, analog crossbars 120a, 120b, and/or the switch controller may use redundant connections in the DSPs 110a, 110b, 110c, 110d or analog crossbars 120a, 120b to form connections. The switch controller 130 may communicate with DSPs 110a, 110b, 110c, 110d using inter-circuit communication, serial peripheral interface, or the like. The switch controller may communicate via an OOB network interface card (e.g., 10 GHz Ethernet) to the datacenter.

The switch controller 130 may manage crossbar configurations between DSPs 110a, 110b, 110c, 110d and analog crossbars 120a, 120b. In addition or alternatively, the switch controller 130 may facilitate resource allocation.

The switch controller 130 may distribute control signaling with DSPs 110a, 110b, 110c, 110d. DSPs 110a, 110b, 110c, 110d may facilitate control signaling to reduce the amount of load for the switch controller 130. The switch controller 130 may facilitate sharing of resources of analog crossbars 120a, 120b.

The switch controller 130 may distribute a network state to DSPs 110a, 110b, 110c, 110d to facilitate coherency between DSPs 110a, 110b, 110c, 110d. Distributing the network state may allow for coherence of routing, medium access control (MAC) address tables, or the like.

Failover mechanisms may be implemented within the switch controller 130. This may ensure that control signaling is reassigned in the event of failure. Control signaling may be reassigned from the switch controller 130 to a DSP 110a, 110b, 110c, 110d of the plurality of DSPs 110a, 110b, 110c, 110d when failover occurs. The switch controller 130 may have other failover functionality (e.g., providing for a successor in the event of failure, provisions for detecting failure, or the like). The fail-over functionality may support default route and “dirty bit marking” to control the switch over to the alternative path.

Redundancy may aid during failover. Switch capacity may be enhanced with redundant output lanes in crossbars, providing alternative routes and ensuring no data loss in case of failures. Non-volatile memory (NVM) may store and recover the crossbar's state after power loss, allowing the system to resume operation without reconfiguration delays.

Failover may be detected in various ways. The switch controller 130 may facilitate proactive monitoring and maintenance. For example, the switch controller 130 may track analog signal metrics to predict link failure. Examples of analog signal metrics include eye characteristics, signal swing, or the like. The switch controller 130 may use the analog signal metrics to predict failover so that latency may be reduced.

For example, in some examples, the system may incorporate a comprehensive suite of monitoring metrics to inform reconfiguration and failover decisions. Beyond eye characteristics and signal swing, metrics such as bit error rate (BER), signal-to-noise ratio (SNR), and latency measurements may be utilized to assess the health of links and optimize resource allocation dynamically. These metrics provide critical insights into the performance of both individual components and the overall network, enabling the switch controller to proactively identify potential disruptions and initiate remedial actions.

Bit error rate (BER) may be particularly significant in evaluating the reliability of data transmissions across crossbars and DSPs. A rising BER may signal degradation in the link quality, prompting the switch controller to reroute traffic through redundant paths or initiate recalibration of equalization parameters. Signal-to-noise ratio (SNR) may complement this by providing a measure of the clarity of the transmitted signals. Low SNR values could trigger adjustments in transmission power levels or request error correction protocols to maintain data integrity.

Quality-of-service (QoS) thresholds may also be integrated into the system's monitoring framework. By tracking parameters such as packet loss, throughput, and jitter, the switch controller can dynamically prioritize traffic based on its classification, ensuring that high-priority data streams receive adequate bandwidth during periods of congestion. For example, critical traffic such as real-time video or financial transactions may be assigned higher QoS thresholds, prompting the switch controller to allocate resources preferentially to maintain service levels.

The system may also implement explicit congestion notification (ECN) as a flow control protocol to augment backpressure mechanisms. In some examples, the switch controller may detect congestion along a particular path and set ECN flags in the packet headers, signaling to upstream devices to reduce the transmission rate. This proactive signaling prevents bottlenecks and mitigates packet loss, ensuring smoother traffic flow through the network. ECN's integration into the switch controller may also enable seamless coordination with other flow control mechanisms, such as rate limiting or dynamic queue management.

The switch controller may employ a feedback loop combining these metrics and protocols to refine its operations continually. For example, real-time analysis of BER and QoS metrics may inform adjustments to ECN thresholds, enabling the system to react more effectively to changing network conditions. Additionally, the use of predictive models based on historical metric data may enhance the system's ability to anticipate failures and preemptively reconfigure traffic paths, thereby minimizing latency and avoiding service disruptions.

In optical network environments or data centers with high traffic variability, these enhanced metrics and protocols may play a pivotal role in maintaining performance. For example, during traffic spikes, the switch controller may use a combination of SNR monitoring and ECN signaling to balance load across redundant crossbars, preventing localized congestion. By integrating advanced metrics and standard protocols into its operations, the system ensures robust, adaptive, and high-performing network management.

In some examples, proactive failover mechanisms may be employed to prevent service disruptions in high-speed network environments. The switch controller may continuously monitor signal integrity and network state, utilizing metrics such as signal-to-noise ratio, eye diagram characteristics, and error rates to detect anomalies. For example, if the switch controller identifies a degradation in the signal quality of a primary crossbar path, it may predict a potential link failure and initiate a failover sequence before the failure occurs.

The failover process may involve rerouting traffic to a redundant crossbar path while maintaining ongoing communication sessions. In one implementation, the switch controller may leverage stored crossbar configurations and equalization parameters in a look-up table (LUT) to expedite the transition to the alternate path. This dynamic rerouting capability ensures that data flow remains uninterrupted, minimizing latency or packet loss during the switchover.

In some examples, the switch controller may also coordinate failover tasks with the digital signal processors (DSPs). For instance, the DSPs may receive real-time alerts from the switch controller regarding the impending failure and may pre-emptively configure their input and output lanes to align with the new routing path. The DSPs may utilize out-of-band (OOB) communication to confirm the state of the redundant path before the failover is finalized, further reducing the risk of traffic disruption.

Proactive failover mechanisms may also include predictive maintenance capabilities, wherein the switch controller tracks usage patterns, power levels, and thermal conditions of crossbar components. By analyzing these metrics, the switch controller may anticipate potential hardware issues and reroute traffic away from affected areas well in advance. This ensures high availability and reliability, particularly in mission-critical environments such as data centers, telecommunications networks, or cloud computing infrastructures.

In another example, the failover mechanism may be employed in a multi-tenant data center where resource contention and high traffic loads are common. The switch controller may prioritize failover paths based on the service-level agreements (SLAs) of individual clients, ensuring that high-priority traffic receives uninterrupted service. This prioritization may be dynamically adjusted based on real-time traffic conditions and client requirements, providing a robust and adaptive failover strategy.

In some examples, the switch controller dynamically resolves resource contention through distributed control mechanisms and real-time traffic monitoring. For example, consider a high-traffic scenario in a data center where multiple clients simultaneously request access to limited bandwidth on a shared output port. The switch controller, in conjunction with the distributed DSPs, may analyze the priority levels of the incoming requests using a pre-configured lookup table (LUT). By assigning higher priority to latency-sensitive applications, such as real-time video streaming, and deferring lower-priority tasks like bulk data transfers, the system ensures optimal resource utilization without overloading the shared port. For example, in achieving load balancing, each, or at least one, DSP may evaluate local traffic conditions and relay its findings to the switch controller. Based on this aggregated data, the switch controller may reconfigure crossbar paths dynamically, redistributing traffic to less congested lanes or enabling redundant pathways to alleviate bottlenecks. For instance, if two DSPs detect a potential conflict on a particular crossbar, mutual exclusion (Mutex) mechanisms may be employed to sequentially grant access, avoiding collisions and maintaining system stability.

Failover scenarios further illustrate the capabilities of the switch controller in preventing data loss and service disruptions. In one example, the switch controller continuously monitors analog signal metrics, such as eye characteristics and signal swing, to detect early signs of link degradation. For example, when a critical link exhibits a rising bit error rate (BER) combined with a decrease in signal-to-noise ratio (SNR). In response, the switch controller proactively initiates failover by redirecting traffic through a redundant crossbar path while simultaneously recalibrating the degraded link. This predictive maintenance workflow minimizes latency during the failover process and ensures uninterrupted data flow.

For example, when a sudden spike in traffic caused by a failover event elsewhere in the network, the switch controller may engage distributed DSPs to manage the increased load by redistributing tasks. For example, DSPs near the affected area may temporarily assume additional responsibilities, such as handling lower-priority traffic or allocating bandwidth to newly active redundant links. Accordingly, load balancing algorithms may dynamically adjust the routing configurations to spread the traffic evenly across the available crossbars, preventing localized congestion and maintaining overall system performance.

In some examples, the switch controller 130 may reserve in-band (IB) bandwidth to facilitate predictable communication. Alternatively or in addition, the switch controller 130 may reserve IB bandwidth for predictable link behavior or latency. The switch controller 130 may use idle symbols detected in physical coding sublayer (PCS). The switch controller 130 may insert in-band communication or perform foreground calibration. The switch controller 130 may allocate crossbar resources for predicted or anticipated traffic, e.g. based on a probabilistic model. The switch controller 130 may use OOB communications such as inter-integrated circuit (I2C), serial peripheral interface (SPI), reduced gigabit media independent interface (RGMII), 10G serializer/deserializer (SERDES), Ethernet, or the like. Star or daisy-chained topologies, or crossbar connectivity may be used for OOB.

The switch controller 130 may perform dynamic bandwidth optimization. Transmit (TX) Path determination may use dynamic method of AECS XBAR from IN to final OUTPUT (e.g., by allowing consecutive frames with “repeat” flag to go through same path without other information (dynamic bandwidth optimization)).

The switch controller 130 may resolve resource grant requests. A switch controller 130 may have various functions. The switch controller 130 may resolve resource grant requests and function as an arbiter of contention. The switch controller 130 may distribute network state (establishing coherency among DSPs). The switch controller 130 may be a repository of current network state information (e.g. MAC tables, priority assignments). The switch controller 130 may be a timing master by establishing time base e.g., medium access protocol (MAP) cycles across DSPs.

The switch controller 130 may connect in various ways. A switch controller 130 may be a separate MCU or may be within a designated DSP or may be located as digital circuitry on a designated crossbar circuit. Various topologies may be used (e.g., star, mesh, daisy chain, or the like). The switch controller 130 may support multiple instances to allow for coherency. Multiple controller systems may support a primary and secondary architecture to resolve conflicts across switch controller 130 instances.

Switch management and control may use various methods. In some examples, IB control may involve a client communicating with the AECS via IB bandwidth by addressing DSPs and/or switch controller 130 directly. Packet or frame headers may be inspected by the DSP for routing within the AECS or sent to the switch controller 130. In another example, the control plane physical layer may involve a client signaling the AECS using a separate network connection carrying control plane traffic.

DSPs, the switch controller, and/or analog crossbars may be interconnected in various ways. OOB signaling may be used within the AECS in which a separate physical layer and connectivity is used for communication among DSPs 110a, 110b, 110c, 110d, analog crossbars 120a, 120b, and/or the switch controller 130. For example, SPI, I2C, or other OOB input/output modes may be used. Control signaling, management, and synchronization may be implemented using OOB signaling within the AECS. Alternatively or in addition, separate connectivity may be used, e.g., e.g. star, daisy chain, mesh, or shared use of Xbar IC redundant capacity. Alternatively or in addition, OOB signaling may be used to maintain the MAP cycle, establish synchronization, update the AECS state, or update the AECS tables.

Distributed control signaling across DSPs 110a, 110b, 110c, 110d and the switch controller 130 may remain synchronized to prevent configuration mismatches. The switch controller 130 may synchronize control signaling for DSPs 110a, 110b, 110c, 110d and the switch controller 130. The switch controller may establish a shared time base for DSPs 110a, 110b, 110c, 110d.

DSPs 110a, 110b, 110c, 110d and analog crossbars 120a, 120b may operate asynchronously. For example, DSPs 110a, 110b, 110c, 110d and analog crossbars 120a, 120b may not rely on centralized management cycles which may allow for faster and more flexible reconfiguration. Therefore, MAP cycles may not be used when DSPs 110a, 110b, 110c, 110d and analog crossbars 120a, 120b operate asynchronously.

In some examples, the system may employ a hybrid approach to synchronization, combining distributed and centralized techniques to optimize performance during peak traffic conditions. The switch controller may act as the central synchronization authority, establishing a shared time base across the digital signal processors (DSPs) and analog crossbars. This centralized synchronization may be implemented using a master-slave clock architecture, with the switch controller distributing precision timing signals to all network components. The use of a standardized protocol, such as IEEE 1588 Precision Time Protocol (PTP), ensures consistent and accurate synchronization across the system.

Alternatively or in addition, the DSPs 110a, 110b, 110c, 110d may be syntonized. For example, a bittide mechanism may be used to achieve syntony. The mechanism that bittide may use for providing frequency-locking feedback to a given node's local clock may be the state (pointer location FIFO pointer (FP)) of the local node's FIFOs (“elastic buffers”, or “receive buffers”) that connect it to other nodes. The local node may compute the difference between the pointer FP and a desired FIFO set point (SP, e.g. mid-point of the FIFO) for each FIFO, average them, scale the average and feed this result to the frequency control of the local oscillator. A positive value signifies that on average the FIFOs are more full than desired, and therefore the local clock should increase its frequency to prevent overflow of the FIFOs. This mechanism is similar to a phase lock loop's phase detector.

In some examples, when involving distributed synchronization, the DSPs may independently manage timing for localized operations while maintaining alignment with the overall network state. This approach reduces the burden on the switch controller during peak traffic, as DSPs leverage local phase-locked loops (PLLs) to dynamically adjust for jitter and clock drift. Each DSP may use its local PLL to achieve fine-grained alignment with neighboring DSPs and crossbars, ensuring seamless data transfer across the network.

During high-traffic periods, the system may implement adaptive synchronization algorithms to balance the load between centralized and distributed methods. For example, a hierarchical synchronization model may be used, wherein the switch controller manages global timing coordination while delegating finer synchronization tasks to regional DSP clusters. This tiered approach minimizes latency and enhances scalability, allowing the system to maintain synchronization even under heavy traffic loads.

Dynamic recalibration during operation further enhances synchronization. In some examples, the switch controller and DSPs may continuously monitor timing deviations using statistical metrics such as mean absolute clock offset and phase variation. When deviations exceed a predetermined threshold, the system may initiate recalibration by adjusting PLL parameters or updating clock signals in real time. This ensures that synchronization remains robust even in environments with high variability, such as optical networks or multi-tenant data centers.

Additionally, the system may utilize synchronization techniques tailored to specific traffic patterns and network topologies. For example, in an optical network with varied data rates and dense wavelength division multiplexing (DWDM), the switch controller may coordinate synchronization at both the optical layer and the electrical layer. By aligning these layers through precise timing signals, the system ensures smooth traffic transitions and prevents bottlenecks during peak usage. This multi-layer synchronization approach is particularly effective in maintaining data integrity and minimizing latency in complex and high-performance network environments.

Load balancing techniques may be used to distribute control tasks based on traffic load and system usage for enhancing fault tolerance. The switch controller 130 may distribute control signaling based on traffic load.

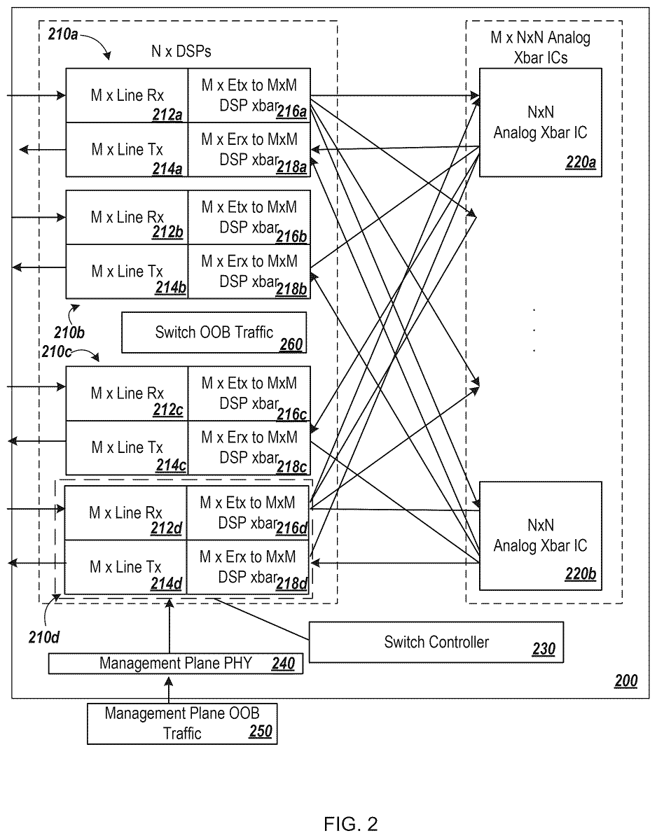

As illustrated in FIG. 2, for AECS 200, a DSP 210a may include an M×Line Rx 212a, an M×Line Tx 214a, an M×ETx to M×M DSP xbar 216a, and an M×ERx to M×M DSP xbar 218a. A DSP 210b may include an M×Line Rx 212b, an M×Line Tx 214b, an M×ETx to M×M DSP xbar 216b, and an M×ERx to M×M DSP xbar 218b. A DSP 210c may include an M×Line Rx 212c, an M×Line Tx 214c, an M×ETx to M×M DSP xbar 216c, and an M×ERx to M×M DSP xbar 218c. A DSP 210d may include an M×Line Rx 212d, an M×Line Tx 214d, an M×ETx to M×M DSP xbar 216d, and an M×ERx to M×M DSP xbar 218d.

DSPs 210a, 210b, 210c, 210d may use high density digital processes that may integrate switch controller 230 functionality. Thus, the switch controller 230 may have its functionality provided by DSPs 210a, 210b, 210c, 210d. DSPs 210a, 210b, 210c, 210d may facilitate control signaling. Another DSP may be designated as a backup for the DSP that functions as a switch controller 230.

The switch controller 230 (e.g., as provided by a DSP) may communicate with a management plane 240 using a separate physical layer. Crossbars may be configured by a management plane 240 which runs inside or outside the AECS (e.g. via a switch controller). This may allow DSPs 210a, 210b, 210c, 210d and switches to settle and/or reacquire either with a fixed time, by polling DSPs 210a, 210b, 210c, 210d and analog crossbars 220a, 220b, or by interrupts/communications from DSPs 210a, 210b, 210c, 210d and analog crossbars 220a, 220b.

The separate physical layer may be integrated in DSPs 210a, 210b, 210c, 210d or within a separate integrated circuit. The management plane physical layer 240 may be connected to a separate switch to provide for redundancy and/or failover. An additional switch controller 230 may be provided to facilitate redundancy and/or failover.

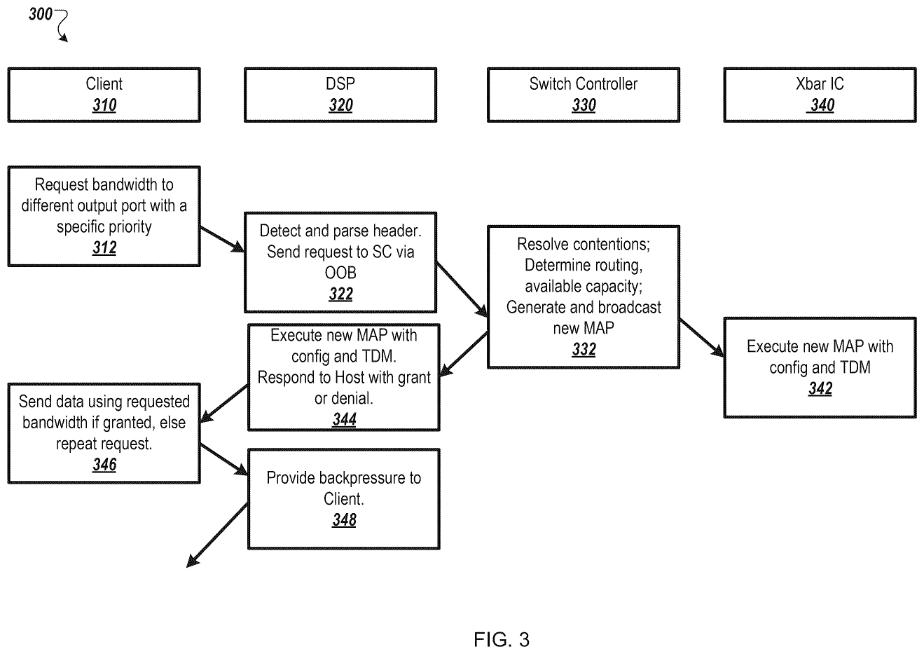

As illustrated in FIG. 3, a timing diagram 300 showing communication between a client 310, a DSP 320, a switch controller 330, and a crossbar IC 340 (i.e., including analog crossbars) is illustrated. The client 310 may communicate with DSP 320 by requesting bandwidth to a different output port with a specific priority, as in block 312. DSP 320 may detect and parse the header and send a request to the switch controller 330 via out-of-band communication, as in block 322. Switch controller 330 may resolve contentions, determine routing and available capacity, and generate and broadcast new MAP, as in block 332. Crossbar IC 340 may execute the new MAP with configuration and time division multiplexing (TDM), as in block 342. DSP 320 may execute new MAP with configuration and TDM, and respond to the host with grant or denial, as in block 344. The client 310 may send data using requested bandwidth if granted, or else repeat the request, as in block 346. DSP 320 may provide backpressure to client 310, as in block 348.

In addition or alternatively, the AECS may be an optical circuit switch (OCS). Any technique suitable for an AECS may be applied to an OCS.

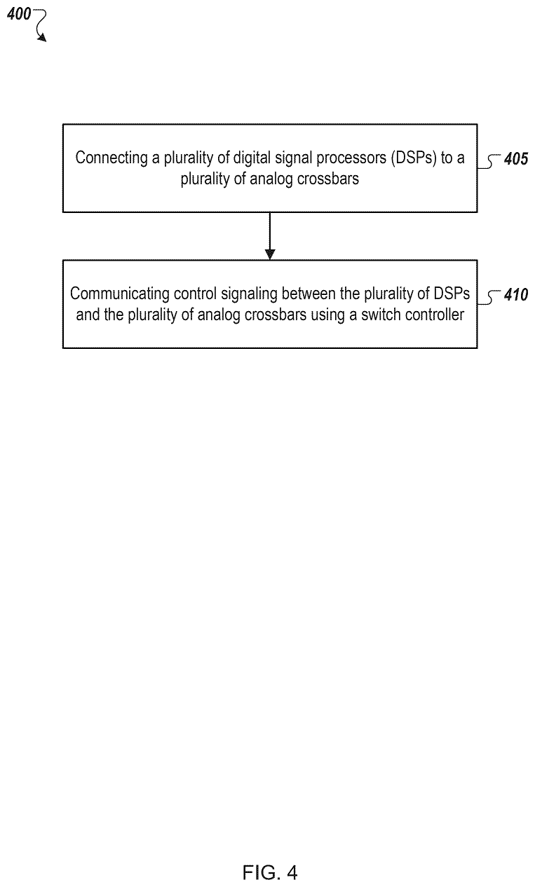

FIG. 4 illustrates a process flow of an example method 400 for a switch controller, in accordance with some examples. The method 400 may be arranged in accordance with some examples.

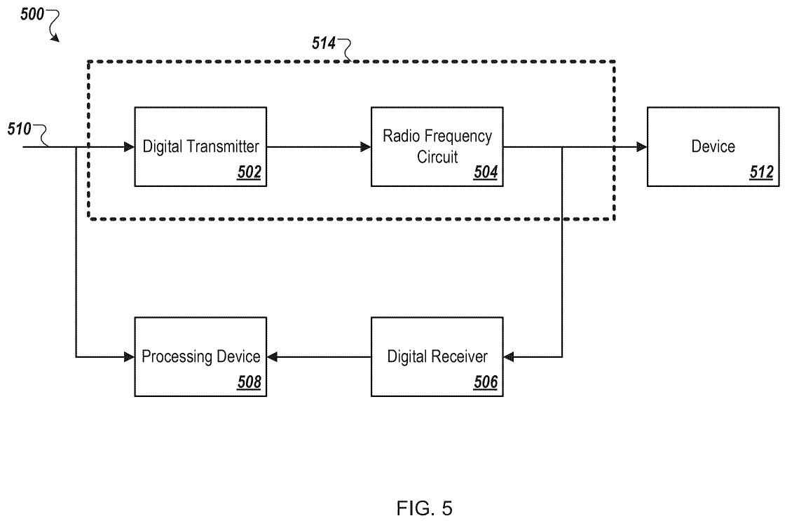

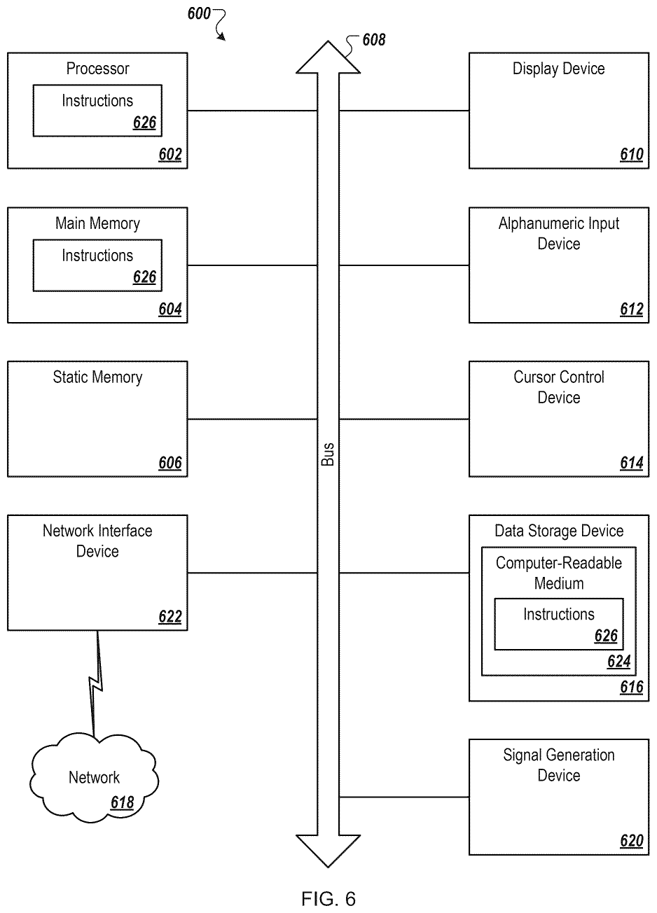

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may connect DSPs to analog crossbars.

At block 410, the processing logic may communicate control signaling between DSPs and analog crossbars using a switch controller.

The processing logic may reassign the switch controller when failover occurs. The processing logic may reserve bandwidth to facilitate predictable communication. The processing logic may perform dynamic bandwidth optimization. The processing logic may resolve resource grant requests. The processing logic may distribute network state to facilitate coherency for DSPs. The processing logic may establish a shared time base for DSPs. The processing logic may communicate via an out-of-band (OOB) network interface card. The processing logic may communicate to the management plane using a separate physical layer. The processing logic may communicate using in-band bandwidth.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500 configured for a switch controller, in accordance with some examples. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute or Electrical and Electronics Engineers (IEEE) 1588v2 device, a Long-Term Evolution (LTE) physical layer (L-PHY), an (S-plane) device, a management plane (M-plane) device, an Ethernet MAC/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In some examples, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

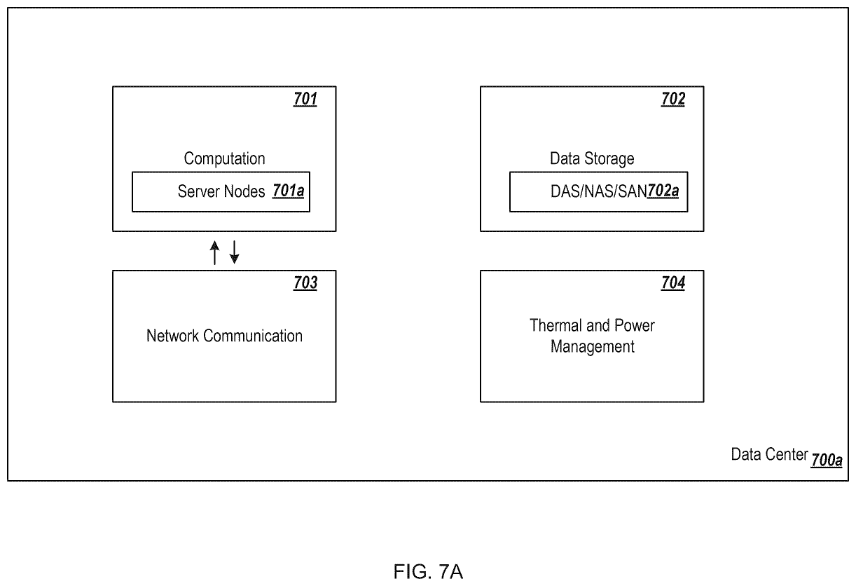

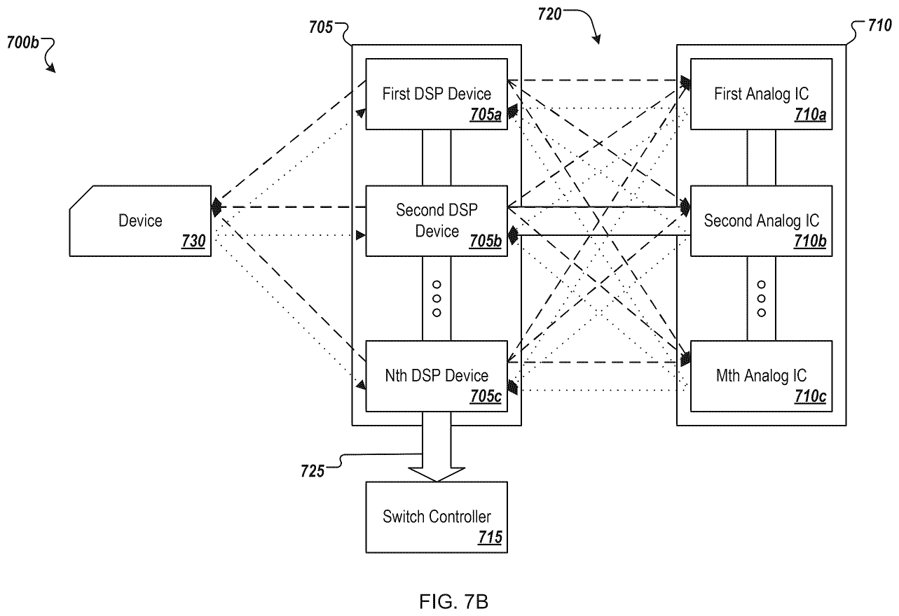

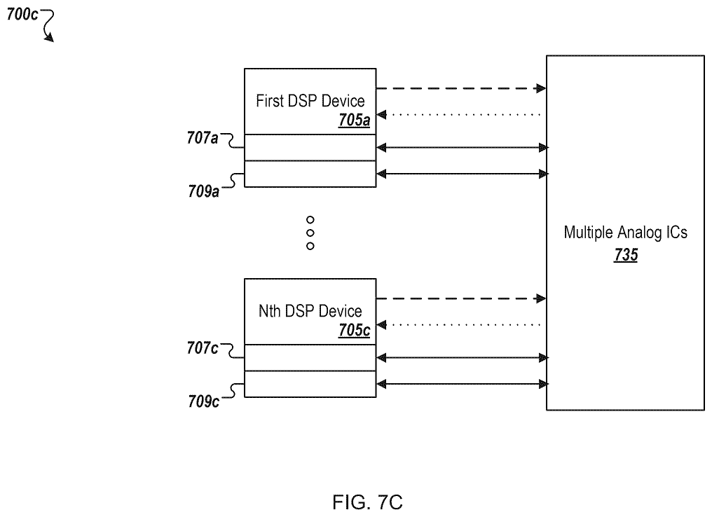

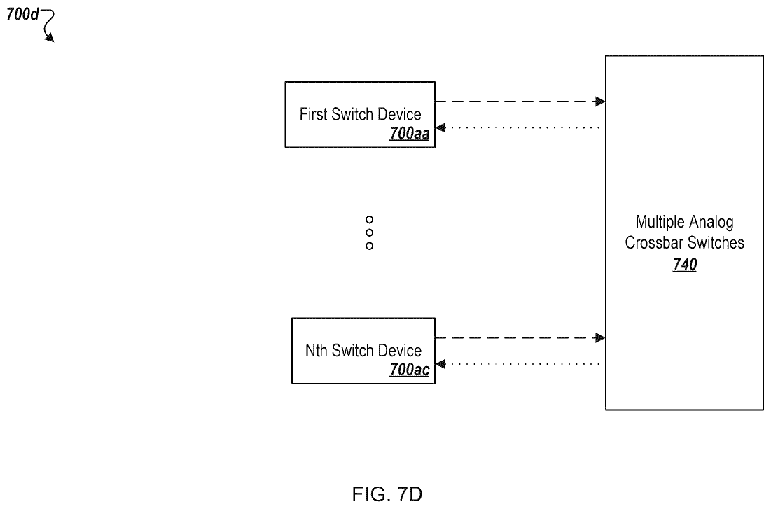

As illustrated in FIG. 7A, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance requirements, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver all of its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10 ns, or the like switching). Alternatively, or additionally, the switch device 700b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

### EXAMPLES

A method may include connecting a plurality of digital signal processors (DSPs) to a plurality of analog crossbars; and communicating control signaling between the plurality of DSPs and the plurality of analog crossbars using a switch controller.

The method may include reassigning the switch controller when failover occurs.

The method may include reserving bandwidth to facilitate predictable communication.

The method may include performing dynamic bandwidth optimization.

The method may include resolving resource grant requests.

The method may include distributing network state to facilitate coherency for the plurality of DSPs.

The method may include establishing a shared time base for the plurality of DSPs.

The method may include communicating via an out-of-band (OOB) network interface card.

The method may include communicating to a management plane using a separate physical layer.

The method may include communicating using in-band bandwidth.

A system may include a switch controller configured to monitor signal metrics associated with one or more crossbars, in which the signal metrics include bit error rate (BER), quality-of-service (QoS) thresholds, and eye diagram characteristics, and to predict potential failover events based on the monitored signal metrics.

The switch controller may be further configured to initiate rerouting of traffic based on predicted failover events to maintain system continuity.

The switch controller may use machine learning algorithms to analyze historical signal metrics and refine failover prediction accuracy.

The switch controller may dynamically adjust signal equalization settings in response to detected signal degradation.

The switch controller may integrate signal swing metrics to anticipate crossbar failures and preemptively reconfigure traffic routes.

A method may include synchronizing a plurality of digital signal processors (DSPs) and analog crossbars using a shared clock signal, and dynamically recalibrating synchronization during operation based on real-time traffic demands.

Recalibration may include adjusting phase-locked loops (PLLs) within the DSPs and crossbars to minimize timing drift during high traffic loads.

The method may include using distributed synchronization to dynamically allocate control signaling tasks among DSPs during peak traffic conditions.

Synchronization recalibration may include jitter correction using feedback from signal integrity monitoring.

Recalibration may be triggered by detecting deviations in synchronization metrics, including skew or clock drift.

A device may include a plurality of digital signal processors (DSPs) and analog crossbars operable to be connected to the DSPs, in which the device integrates in-band (IB) and out-of-band (OOB) communication to enable coherent control signaling across the DSPs and crossbars.

IB communication may be used for real-time traffic coordination, and the OOB communication may be used for crossbar configuration and management.

The switch controller may be configured to seamlessly transition between IB and OOB communication during reconfiguration events.

The OOB communication may be implemented using serial peripheral interface (SPI), inter-integrated circuit (I2C), or Ethernet protocols.

IB communication may leverage medium access protocol (MAP) cycles to synchronize traffic flow among DSPs.

A method may include coordinating traffic flow between digital signal processors (DSPs) and analog crossbars using a combination of in-band (IB) and out-of-band (OOB) communication, and dynamically selecting the communication type based on operational context.

The OOB communication may be prioritized for failover and system reconfiguration, and IB communication may be prioritized for high-speed traffic handling.

The method may include integrating signaling protocols, including explicit congestion notification (ECN), within IB communication to enhance flow control.

The system may dynamically allocate bandwidth between IB and OOB communication based on traffic load and configuration requirements.

The system may synchronize IB and OOB communication using a shared time base to prevent signaling conflicts.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs);
a plurality of analog crossbars operable to be connected to the plurality of DSPs; and
one or more switch controllers operable to facilitate control signaling between the plurality of DSPs and the plurality of analog crossbars.

2. The device of claim 1, wherein the one or more switch controllers is operable to manage crossbar configurations between the plurality of DSPs and the plurality of analog crossbars.

3. The device of claim 1, wherein the one or more switch controllers is operable to facilitate resource allocation.

4. The device of claim 1, wherein the plurality of DSPs are operable to facilitate control signaling.

5. The device of claim 1, wherein the one or more switch controllers is operable to distribute network state to facilitate coherency among the plurality of DSPs.

6. The device of claim 1, wherein the one or more switch controllers is operable to facilitate sharing of resources of the plurality of analog crossbars.

7. The device of claim 1, wherein control signaling is reassigned from the one or more switch controllers to a DSP of the plurality of DSPs when failover occurs.

8. The device of claim 1, wherein the one or more switch controllers is operable to track analog signal metrics to predict link failure.

9. The device of claim 1, wherein the one or more switch controllers is operable to reserve in-band (IB) bandwidth to facilitate predictable communication.

10. The device of claim 1, wherein the one or more switch controllers is operable to synchronize control signaling for the plurality of DSPs and the switch controller.

11. The device of claim 1, wherein the one or more switch controllers is operable to establish a time base for the plurality of DSPs.

12. The device of claim 1, wherein the one or more switch controllers is operable to distribute control signaling.

13. The device of claim 1, wherein the one or more switch controllers is operable to perform dynamic bandwidth optimization.

14. The device of claim 1, wherein the one or more switch controllers is a microcontroller unit (MCU).

15. The device of claim 1, wherein the one or more switch controllers is a DSP of the plurality of DSPs.

16. The device of claim 1, wherein the one or more switch controllers is operable to resolve resource grant requests.

17. The device of claim 1, further comprising an additional switch controller.

18. A device comprising:
a plurality of digital signal processors (DSPs); and
a plurality of analog crossbars operable to be connected to the plurality of DSPs,
wherein a DSP of the plurality of DSPs is a switch controller operable to facilitate control signaling.

19. The device of claim 18, wherein another DSP of the plurality of DSPs is designated as a backup for the switch controller.

20. The device of claim 18, wherein the switch controller is operable to communicate with a management plane using a separate physical layer.
